(19) United States
(12) Patent Application Publication
(10) Pub. No.: US 2006/0257934 A1
(43) Pub. Date: Nov. 16, 2006

(54) Cell-based assay for the quantitative high throughput screening of gamma-aminobutyric acid-induced halide transport

(76) Inventors: Svetlana Tertyshnikova, Clinton, CT (US); Steven Ira Dworetzky, Middlefield, CT (US); Andrew Bullen, Southington, CT (US); Joanne T. Natale, Guilford, CT (US); Corinne Griffin, Southington, CT (US); David Weaver, Franklin, TN (US)

Correspondence Address: LOUIS J. WILLE;BRISTOL-MYERS SQUIBB COMPANY, PATENT DEPARTMENT, P O BOX 4000, PRINCETON, NJ, 08543-4000, US

(21) Appl. No.: 11/400,990

(22) Filed: Apr. 10, 2006

Related U.S. Application Data
(60) Provisional application No. 60/672,599, filed on Apr. 19, 2005.

(51) Int. Cl. C40B 30/06

(52) U.S. Cl. 435/7.1

(57) ABSTRACT

The present invention is directed to a rapid, quantitative screening procedure of γ-aminobutyric acid (GABA)-mediated halide transport in cells with the use of a conventional 384-well fluorescence plate reader (FLIPR). The halide sensor is a novel yellow fluorescent protein (YFP) with mutations at positions 46/148/152 that exhibits bright fluorescence at 37° C.

This application claims priority benefit to U.S. Provisional Application Ser. No. 60/672,599, filed on Apr. 19, 2005.

### FIELD OF THE INVENTION

The subject matter disclosed and claimed herein relates to assays for screening putative neurological and affective disorder therapeutics. An embodiment of the present invention relates to an assay for screening compounds having the potential to modulate gamma-aminobutyric acid (hereinafter “GABA”) receptor activity. More particularly, an embodiment of the invention is a high-throughput assay involving the use of a reporter molecule, such as mutant YFP variant disclosed herein, for determining GABA-mediated halide flux in cells.

### BACKGROUND OF THE INVENTION

GABA is the major inhibitory neurotransmitter in the central nervous system. GABA is released from GABA-ergic neurons and binds two major types of GABA receptors: 1) ionotropic GABA(A) receptors; and (2) metabotropic GABA(B) receptors. GABA(A) receptors are the sites of action for benzodiazepines, barbiturates, anesthetics and neurosteroids. GABA(A) receptors belong to the ligand-gated ion channel (LGIC) superfamily. It is a heteropentamer, with all of its five subunits contributing to the pore formation. To date, eight subunit isoforms have been cloned (α, β, γ, δ, ε, π, θ, and ρ). The native GABA(A) receptor, in most cases, is made up of 2α,2 β and 1 γ subunit. Most of the subunit families have multiple members (αa1-6, β1-4, γ1-4, δ and ρ 1-2). The pharmacology of the GABA(A) receptor depends on the subunit composition.

The binding of GABA to GABA(A) receptors results in opening of chloride (Cl⁻) channels that in turn leads to the inhibition of neural activity. Clinical compounds such as benzodiazepines, barbiturates, anesthetics and neurosteroids modulate the function of GABA(A) receptors, producing a spectrum of behavioral effects including: hypnotic, sedative, anticonvulsant, muscle relaxant, anxiolytic (positive modulators), memory enhancement, anxiogenic and convulsants (negative modulators).

Drug discovery of ion channel modulators traditionally relies on low throughput electrophysiological techniques as a functional assay, because binding assays are not always predictive of receptor/channel activity. Thus, a functional high-throughput assay that adequately assesses GABA(A) receptor activity would greatly benefit discovery of novel, subtype-specific GABA(A) receptor modulators.

The green fluorescent protein (GFP) from the jellyfish Aequorea Victoria is an important tool for a number of biological system applications. Among GFP variants, yellow fluorescent protein (YFP) has a unique property to be quenched by Cl⁻ions (or other halides) (Jarayaman et al., (2000) JBC, 275 (9) 6047-6050; Nagai et al. (2002) Nat. Biotech. 20:87-90). Others have constructed and employed YFP mutants in screening assays (see e.g., Kruger et. al., Neuroscience Letters 380 (2005) 340-345; and Nagai et. al., Nature Biotech., Vol. 20, pp. 87-90 (2002)). However, these efforts differ from the assay of the instant invention in that the multiply-modified YFP mutants described herein (e.g., mutations at amino acid positions 46/148/152) have optimized temperature stability and fluorescence characteristics.

There is a need for a functional high-throughput assay that adequately assesses GABA(A) receptor activity for the screening of subtype-specific GABA receptor modulators. Use of GFP variants, such as YFP, has expedited development of such a high-throughput assay as described and claimed herein.

### SUMMARY OF THE INVENTION

One embodiment of the present invention is a cell-based assay for identifying a compound that modulates the activity of a GABA receptor. The assay includes the steps of: (a) providing a cell which expresses a GABA receptor and at least one reporter molecule; (b) contacting the cell with GABA and a halide molecule; (c) contacting the cell with a test compound; and (d) determining whether the test compound modulates the activity of the GABA receptor. The reporter molecule may be a green fluorescent protein or a green fluorescent protein variant, such as a yellow fluorescent protein. An example of a yellow fluorescent protein is embodied in the nucleotide sequence of SEQ ID NO:5, and the amino acid sequence set forth in SEQ ID NO:6. The determining step may be carried out by comparing the activity of the reporter molecule(s) prior to and subsequent to the step of contacting the cell with the test compound. Further, the GABA receptor may be GABA(A) and the halide molecule may be iodide.

In another aspect, the present invention is directed to a cell-based assay for identifying a compound that modulates the activity of a GABA receptor, the assay comprising the steps of: (a) providing a cell which expresses a GABA(A) receptor and a yellow fluorescent protein molecule; (b) contacting the cell with GABA and iodide; (c) contacting the cell with a test compound; and (d) determining whether the test compound modulates the activity of the GABA receptor. The yellow fluorescent protein molecule is embodied in the nucleotide sequence set forth in SEQ ID NO:5 and may have the amino acid sequence set forth in SEQ ID NO:6.

In another aspect, the present invention is directed to a cell-based assay for identifying a compound that modulates the activity of a GABA receptor, the assay comprising the steps of: (a) providing a cell which expresses a GABA(A) receptor and a yellow fluorescent protein molecule having the nucleotide sequence of SEQ ID NO:5; (b) contacting the cell with GABA and iodide; (c) contacting the cell with a test compound; and (d) comparing the fluorescence of the yellow fluorescent protein molecule prior to and subsequent to the step of contacting the cell with a test compound to determine whether the test compound modulates the activity of the GABA receptor.

In another aspect, the present invention is directed to a nucleic acid molecule comprising or consisting of the nucleotide sequence of SEQ ID NO:5, a vector comprising such a nucleic acid molecule, a host cell comprising such a vector, a polypeptide encoded by such a nucleic acid molecule and a polypeptide expressed by such a host cell.

In another aspect, the present invention is directed to a polypeptide comprising or consisting of the amino acid sequence set forth in SEQ ID NO:6.

### BRIEF DESCRIPTION OF THE DRAWINGS

FIG. 1 shows GABA-induced concentration-response at iodide concentrations of 0. 1, 1, 5, and 10 mM.

FIG. 2 shows the relationship between iodide concentration and GABA EC₅₀.

FIG. 3 shows the concentration-dependent increase of the GABA-induced fluorescent signal by Diazepam.

FIG. 4 shows the concentration-dependent increase of the GABA-induced fluorescent signal by the neurosteroid pregnanolone.

FIG. 5 shows the concentration-dependent inhibition of the GABA-induced fluorescent signal by Bicuculline.

### DETAILED DESCRIPTION OF THE INVENTION

The present invention is directed to a rapid, quantitative screening procedure of GABA-mediated halide transport in cells using a 384- well fluorescence plate reader (FLIPR). The halide sensor is desirably a yellow fluorescent protein (YFP) with mutations at amino acid positions 46, 148, and 152 that exhibits bright fluorescence at 37° C. GABA(A) receptor function was assayed as a normalized change in fluorescence in response to extracellular addition of iodide and GABA, resulting in decreased YFP fluorescence due to GABA-mediated iodide entry. The resulting GABA-induced signal is modulated by benzodiazepines, barbiturates, neurosteroids, and a chloride channel blocker (e.g., bicuculline). The signal observed is consistent with known electrophysiological data.

### EXAMPLES

The section immediately following sets forth materials and methods used in the present invention. Examples of an assay of the invention follows.

YFP Variant Construction

The pcDNA3/Topaz cDNA plasmid is an ultra-bright yellow variant of Green Fluorescent Protein (GFP) from Aurora Biosciences Corporation that is optimized for high-level expression in mammalian cells. The coding region (CDS) contains 720 nucleotides (+6 of the Kozak sequence), or 240 amino acids (+2 of the Kozak sequence). Site-directed mutagenesis was used to change amino acids at the following positions; 148 (Histidine to Glutamine), 152 (Isoleucine to Leucine), and 46 (Phenylalanine to Leucine). The objective was to make Topaz brighter than other fluorescent proteins, less temperature-sensitive, and capable of being used as a halide sensor to finctionally screen anion channel activity.

Mutagenesis was performed using pcDNA3/Topaz as a template with Stratagene's QuikChange™ site-directed mutagenesis kit employing pfu Turbo polymerase. The methods followed the manufacturer's recommended protocol. The first round of PCR (polymerase chain reaction), using the H148Q/I152L primer pair (see Table below) containing the desired mutations, was performed with the following temperature cycling: an initial 95° C. for 3 minutes to denature the template DNA, then denaturation at 95° C. for 30 seconds, annealing at 55° C. for 1 minute, and extension at 68° C. for 12.5 minutes, for a total of 14 cycles. After an aliquot was run on a 1% agarose gel to confirm a product, the reaction was Dpn I-treated to remove the DNA parental strand, and the resulting DNA incorporating the desired mutations was transformed into XL 1-Blue E. coli competent cells.

Bacterial colonies were cultured and DNA isolated with the Promega Wizard Plus miniprep system. Isolated DNA was sequenced to confirm the presence of the desired mutations. The H148Q/I152L mutant construct was transiently transfected into CHO cells, and a flux assay demonstrated that the mutant was brightly fluorescent when incubated in low-chloride media at 29° C. To enhance fluorescence at 37° C., and to increase the construct's resistance to pH and Cl- fluctuations, a mutation was made at amino acid position 46. Primer pair F46L was used in a second round of mutagenesis, using the 148/152 mutant construct as the template. Cycle parameters were: 95° C. for 3 minutes, followed by denaturation at 95° C. for 30 seconds, annealing at 55° C. for 1 minute, and extension at 68° C. for 12 minutes, for a total of 12 cycles. Again, the reaction was enzymatically treated with Dpn I, and transformed. Resulting DNA minipreps were fully sequenced to confirm the amino acid change at position 46 and to ensure that no PCR errors were introduced during the procedure.

The final construct, H148Q/I152L/F46L, was further tested for use as a halide sensor. Plasmid pcDNA3/TopazH148Q/I152L/F46L was transfected into CHO cells, and a fluorescent flux assay revealed an increase in fluorescence at 37° C. This cDNA construct demonstrated superior fluorescence when compared to the 148/152 mutant, at either 29° C. or 37° C. The TopazH148Q/I152L/F46L sequenced was subcloned into the vector pcDNA3.1 (+) hygro (5′ BamHI/3′ Xba I) in order to prepare stable cell lines. The results reflect that the mutation at position 46 increases the efficiency of maturation of the chromophore, especially at 37° C., and maintains/confers halide sensitivity.

PCR Primers for Mutagenesis

| | |
|---|---|
| Forward primer for H148Q/I152L: | |
| 5′ CTACAACAGCCAGAACGTCTATCTCATGGCCGAC | (SEQ ID NO:1) |
| 3′ | |
| Reverse primer for H148Q/I152L: | |
| 5′ GTCGGCCATGAGATAGACGTTCTGGCTGTTGTAG | (SEQ ID NO:2) |
| 3′ | |
| Forward primer for F46L: | |
| 5′ GACCCTGAAGTTAATCTGCACCACCGG 3′ | (SEQ ID NO:3) |
| Reverse primer for F46L: | |
| 5′ CCGGTGGTGCAGATTAACTTCAGGGTC 3′ | (SEQ ID NO:4) |

Nucleotide Sequence of YFP Variant (Topaz “Halide Sensor” H148Q/I152L/F46L; Kozak CDS, 726 bp; SEQ ID NO:5)

| | | | | |
|---|---|---|---|---|
| GCCACCATGG | TGAGCAAGGG | CGAGGAGCTG | TTCACCGGGG | 60 |
| TGGTGCCCAT | CCTGGTCGAG | | | |
| CTGGACGGCG | ACGTAAACGG | CCACAAGTTC | AGCGTGTCCG | 120 |
| GCGAGGGCGA | GGGCGATGCC | | | |
| ACCTACGGCA | AGCTGACCCT | GAAGTTAATC | TGCACCACCG | 180 |
| GCAAGCTGCC | CGTGCCCTGG | | | |
| CCCACCCTCG | TGACCACCTT | CGGCTACGGC | GTGCAGTGCT | 240 |
| TCGCCCGCTA | CCCCGACCAC | | | |
| ATGCGCCAGC | ACGACTTCTT | CAAGTCCGCC | ATGCCCGAAG | 300 |
| GCTACGTCCA | GGAGCGCACC | | | |
| ATCTTCTTCA | AGGACGACGG | CAACTACAAG | ACCCGCGCCG | 360 |
| AGGTGAAGTT | CGAGGGCGAC | | | |
| ACCCTGGTGA | ACCGCATCGA | GCTGAAGGGC | ATCGACTTCA | 420 |
| AGGAGGACGG | CAACATCCTG | | | |
| GGGCACAAGC | TGGAGTACAA | CTACAACAGC | CAGAACGTCT | 480 |
| ATCTCATGGC | CGACAAGCAG | | | |
| AAGAACGGCA | TCAAGGTGAA | CTTCAAGATC | CGCCACAACA | 540 |
| TCGAGGACGG | CAGCGTGCAG | | | |
| CTCGCCGACC | ACTACCAGCA | GAACACCCCC | ATCGGCGACG | 600 |
| GCCCCGTGCT | GCTGCCCGAC | | | |
| AACCACTACC | TGAGCTACCA | GTCCGCCCTG | AGCAAAGACC | 660 |
| CCAACGAGAA | GCGCGATCAC | | | |
| ATGGTCCTGC | TGGAGTTCGT | GACCGCCGCC | GGGATCACTC | 720 |
| TCGGCATGGA | CGAGCTGTAC | | | |

Amino Acid Sequence of YFP Variant (Topaz/“Halide Sensor” H148Q/I152L/F46L; Kozak CDS, 242 amino acids; (SEQ ID NO:6)

| | | | | |
|---|---|---|---|---|
| ATMVSKGEEL | FTGVVPILVE | LDGDVNGHKF | SVSGEGEGDA | 60 |
| TYGKLTLKLI | CTTGKLPVPW | | | |
| PTLVTTFGYG | VQCFARYPDH | MRQHDFFKSA | MPEGYVQERT | 120 |
| IFFKDDGNYK | TRAEVKFEGD | | | |
| TLVNRIELKG | IDFKEDGNIL | GHKLEYNYNS | QNVYLMADKQ | 180 |
| KNGIKVNFKI | RHNIEDGSVQ | | | |
| LADHYQQNTP | IGDGPVLLPD | NHYLSYQSAL | SKDPNEKRDH | 240 |
| MVLLEFVTAA | GITLGMDELY | | | |
| K | | | | 241 |

Cell Lines and Transfection

Doubly transfected cell lines were generated that express GABA_{A} receptor (rat α1β2 γ2) together with a yellow fluorescent protein (YFP) Topaz-based halide sensor (46/148/152 mutant). Preferably, a quadruple stable cell line expressing the three GABA subunits (alpha, beta, gamma) necessary for a functional channel with the mutant YFP halide sensor may be used. Using a clonal cell line under optimized assay conditions permits high-throughput screening of compounds per day with high reliability and reproducibility.

Fluorescence Assay: Data Acquisition and Analysis

Doubly transfected cells were plated onto black-walled, clear-bottomed, poly-D-lysine-coated 384-well plates (Becton Dickinson Biosciences). Prior to the assay, the cell medium was removed and replaced with chloride-free plating medium (CFPM; see the composition below). After the incubation in CFPM for 3-4 hours at 37° C. in a 5% CO₂ atmosphere, the medium was removed and replaced with chloride-free assay buffer (CFAB; see the composition below ), containing the final concentrations of test compounds. The cells were incubated for 15-20 minutes in the dark (to preserve fluorescence of the YFP) at room temperature (RT). Once the incubation was complete, the cell plates were transferred to the FLIPR (Molecular Devices Inc., Sunnyvale, Calif.) for the assay.

YFP was excited with 488 nm wavelength light and the fluorescence measured using a 540/60 nm bandpass emission filter. FLIPR settings were routinely adjusted so that the background fluorescence reading at the beginning of the assay was 20,000-50,000 counts/ms. After measuring a baseline readout of 10 seconds, the stimulus buffer was added to the well and signal was recorded for 2-4 more minutes. The stimulus buffer comprised CFAB, except that the sodium gluconate component was replaced with sodium iodide. Note that the addition of the iodide causes quenching of the fluorescent signal. In the majority of the experiments, the final concentration of sodium iodide in the stimulus buffer was about 5 mM.

The fluorescence response was corrected for the background fluorescence, as well as for the fluorescence changes, caused by iodide only. Relative fluorescence intensity change, calculated as a ratio of the amplitude of the signal to the background fluorescence (F/Of), was used as an indication of the GABA-dependent iodide influx. The initial analysis and data export was done using FLIPR-384 software (Version 1.25).

Microsoft Excel® was used to plot concentration-response curves and determine an EC₅₀ value. To construct GABA concentration-response curves, the relative fluorescence intensity changes at given concentrations of GABA were normalized to the one, induced by the highest concentration of GABA, and multiplied by 100 to express it as percent of control.

The magnitude of the enhancement or inhibition of the GABA-dependent fluorescence intensity change by a test compound, was measured by dividing the GABA-induced signal elicited in the presence of a given concentration of a test compound by the control signal elicited by GABA alone, expressed as percent of control. Control responses were obtained at approximately EC₅₀ for GABA, determined in previous experiments.

Concentration-response curves for individual experiments were obtained after pooling data from at least 3 wells tested for the same concentration of a test compound. Data are presented as Mean±SEM.

Halide Sensor Assay Solutions

a. Chloride-Free Plating Medium (CFPM):

| | | |
|---|---|---|
| Sodium gluconate | 109 | mM |
| Potassium gluconate | 5.4 | mM |
| MgSO₄.7H₂O | 0.81 | mM |
| Sodium bicarbonate anhydrous | 26.2 | mM |
| Hemicalcium gluconate | 1.7 | mM |
| NaH₂PO₄ | 1.4 | mM |
| HEPES | 25 | mM |
| D-(+)-Glucose | 5.5 | mM |
| MEM Vitamin solution (100X, GIBCO) | 10.0 | mL/L |
| MEM Amino acids solution (50X, GIBCO) | 20.0 | mL/L |
| L-Glutamine (GIBCO) | 2 | mM |

b. Chloride-Free Assay Buffer (CFAM):

| | |
|---|---|
| Sodium gluconate | 140 mM |
| Potassium gluconate | 2.5 mM |
| Hemimagnesium gluconate | 3.1 mM |
| Hemicalcium gluconate | 3 mM |
| HEPES | 10 mM |
| D-(+)-Glucose | 5.5 mM |

### Example 1

### GABA-Induced Halide Transport Assay

The GABA-induced halide transport assay was optimized to minimize basal halide transport and to maximize the sensitivity. Chloride-free plating medium and chloride-free assay buffers (discussed above), were used to increase assay sensitivity by minimizing basal halide transport and increasing the signal-to-noise ratio. The signal was initiated by addition of the stimulus buffer containing iodide alone or with the agonist (GABA).

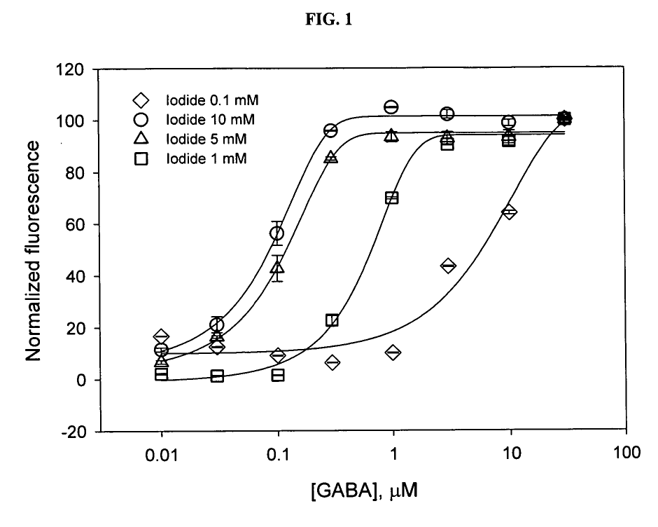

In the doubly-transfected cells, cultured on 384-well plates, iodide concentration of 1 -10 mM in the stimulus buffer yielded reproducible signal from well to well, and could reliably detect an activation of GABA-dependent halide transport produced by low concentrations of GABA (FIG. 1). An iodide concentration of 0.1 mM in the stimulus buffer did not generate a reproducible fluorescent signal below 3 μM of GABA, whereas 20 mM of iodide caused significant quenching of YFP fluorescence, independent of GABA concentration (data not shown).

FIG. 1 reflects GABA-induced concentration responses at 0.1, 1, 5 and 10 mM of iodide. Relative fluorescence intensity change was calculated as the ratio of the amplitude of the signal (F) to the background fluorescence (F₀). The relative fluorescence intensity changes were normalized to the maximum signal induced by the highest concentration of GABA (100%) and plotted against GABA concentrations.

Average EC₅₀ values for GABA at 1, 5 and 10 mM of iodide in the stimulus buffer were (in μM): 0.56±0.07, 0.27±0.03 and 0. 13±0.07, correspondingly (Mean±SEM, data pooled from 2-18 individual experiments). The published data obtained from electrophysiological recordings indicate that α1- containing rat isoforms of GABA(A) receptor expressed in HEK cells exhibit “intermediate” sensitivity to GABA with an EC₅₀ in the range of 0.6 to 7 μM. In the present invention, data obtained from electrophysiological recordings in HEK cells transiently expressing a rat α1β2γ2 isoform showed EC₅₀ 7.55±0.58 μM (n=3-6 cells).

The lower EC₅₀ values in the fluorescence assay may be attributed to a higher sensitivity of the fluorescence assay versus traditional electrophysiological techniques. Specifically, the difference may be due to: 1) different charge carrier (iodide in the fluorescence assay versus chloride in the whole-cell current measurements); it has been reported for YFP-H148Q mutant, that based on YFP quenching properties, its selectivity for iodide is higher than for chlorine (Jayaraman et al., 2000); and 2) fluorescence measurements are performed using a large population of cells, summing a greater signal.

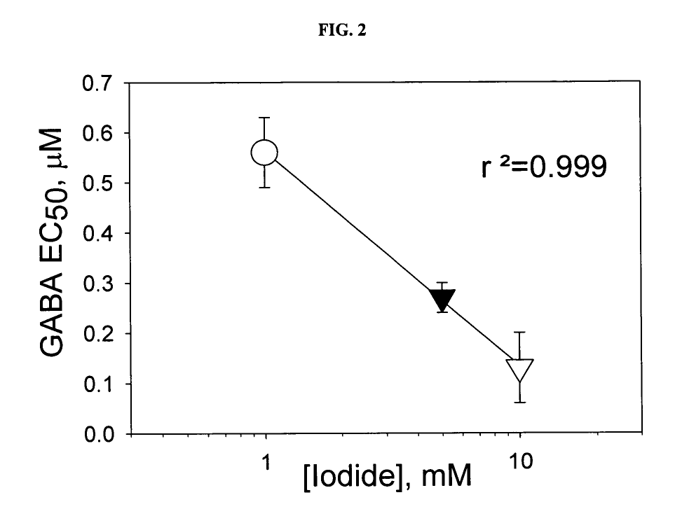

Analysis of the data revealed a linear relationship (r²=0.999) between the GABA EC₅₀ values and the amount of iodide in the stimulus buffer within 1-10 mM iodide range (shown in FIG. 2). The relationship suggests that iodide as a charge carrier may have an influence on the assay sensitivity.

### Example 2

### Testing of Known GABA Modulators

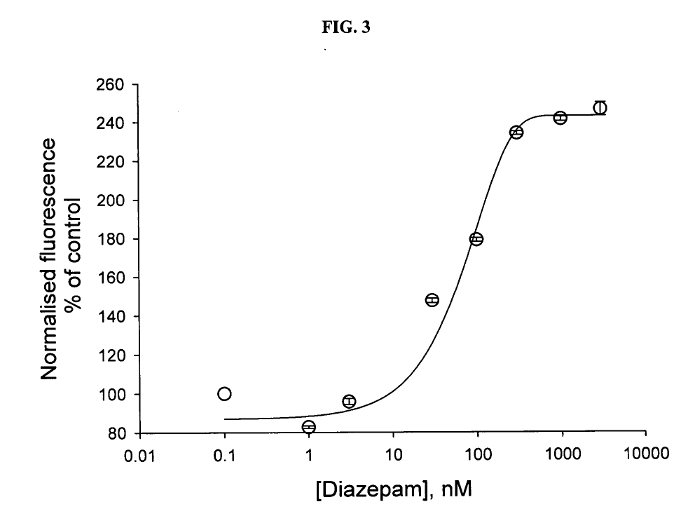

A number of known GABA(A) receptor modulators were tested in the assay, the results of which are shown in FIGS. 3, 4, and 5. The GABA-induced response was positively modulated by diazepam (EC₅₀ 32.2±8.7 nM, n=6 ), pentobarbital (EC₅₀ 36.95±19.1 μM, n=2); neurosteroid allopregnanolone (EC₅₀ 42.5±16.9 nM, n=2); and inhibited by the competitive antagonist bicuculline (IC₅₀ 4.7±0.9 μM, n=2).

The published data obtained from electrophysiological recordings indicate that α1-containing isoforms of the GABA(A) receptor in various expression systems exhibit EC₅₀ values for diazepam in the range of 53-70 nM. In neuronal-like cell line NT-2 N, the EC₅₀ for diazepam was 74 nM, 122nM in hippocampal granule cells. In the present invention, data obtained from electrophysiological recordings in HEK cells transiently expressing rat α1α2γ2 isoform showed an EC₅₀ value of 10 nM (n=3-6 cells).

FIG. 3 reflects that Diazepam causes a concentration-dependent increase in GABA-induced fluorescent signal. Diazepam at concentrations of 1-3000 nM was applied against a constant concentration of GABA at 0.25 μM (approximately EC₅₀ value).

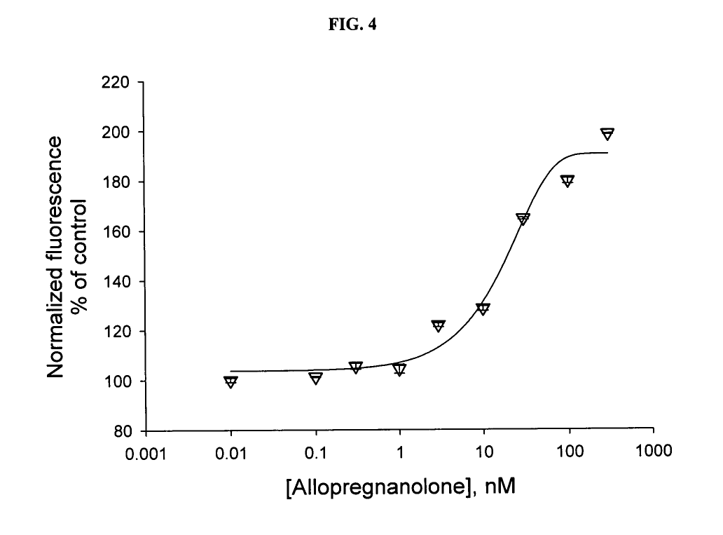

FIG. 4 reflects that the neurosteroid allopregnanolone causes a concentration-dependent increase in GABA-induced fluorescent signal. Allopregnanolone at concentrations of 0.1-300 nM was applied against a constant concentration of GABA at 0.25 μM (approximately EC₅₀ value).

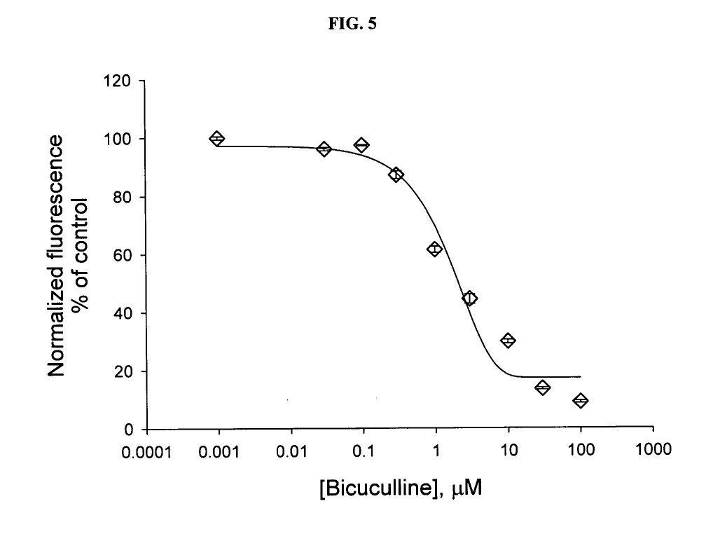

FIG. 5 reflects that Bicuculline causes a concentration-dependent inhibition of GABA-induced fluorescent signal. Bicuculline at concentrations of 0.3-100μM was applied against a constant concentration of GABA at 0.25 μM (approximately IC₅₀ value).

As shown in the Examples and throughout the specification, an embodiment of the present invention is directed to a rapid, quantitative screening procedure of GABA-mediated halide transport in cells with the use of a conventional 384- well fluorescence plate reader (FLIPR). The halide sensor is desirably the inventive novel yellow fluorescent protein (YFP) with mutations at positions 46/148/152 that exhibits bright fluorescence at 37° C. GABA(A) receptor function was assayed as a normalized change in fluorescence in response to extracellular addition of iodide and GABA, resulting in decreased YFP fluorescence due to GABA-mediated iodide entry. The resulting GABA-induced signal was shown to be modulated by benzodiazepines, barbiturates, neurosteroids and chloride channel blockers (e.g., bicuculline), consistent with known electrophysiological data. The assay facilitates the screening of novel modulators of GABA(A) receptors, including GABA subtype-specific modulators, as well as other iodide-permeable chloride channels and transporters. Due to its high sensitivity, the assay is useful as a liability screen for CNS-penetrant compounds.

While the invention has been described in connection with specific embodiments therefore, it will be understood by those of ordinary skill in the art that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims. All references cited herein are expressly incorporated in their entirety.

What is claimed is:

1. A high-throughput cell-based assay for identifying a compound that modulates the activity of a gamma-aminobutyric acid (GABA) receptor, comprising the steps of:
(a) providing a cell which co-expresses a GABA receptor and a yellow fluorescent (YFP) reporter molecule, wherein said YFP reporter comprises at least two mutations, wherein one mutation is at position 148;
(b) contacting said cell with GABA and a halide molecule;
(c) contacting said cell with a test compound; and
(d) determining whether said test compound modulates the activity of said GABA receptor.

2. The assay of claim 1 wherein said mutations are at positions 46 and 148 of the YFP molecule.

3. The assay of claim 1 wherein said mutations are at positions 148 and 152 of the YFP molecule.

4. The assay of claim 1 wherein said mutations are at positions 46, 148, and 152 of the YFP molecule.

5. The assay of claim 4, wherein said YFP is encoded by the nucleotide sequence of SEQ ID NO:5.

6. The assay of claim 5, wherein said nucleotide sequence encodes the amino acid sequence set of SEQ ID NO:6.

7. The assay of claim 1, wherein said determining step is carried out by comparing the activity of said reporter molecule prior and subsequent to said step of contacting said cell with said test compound.

8. The assay of claim 1, wherein said GABA receptor is GABA(A).

9. The assay of claim 1, wherein said halide molecule is iodide.

10. A cell-based assay for identifying a compound that modulates the activity of a GABA receptor, comprising the steps of:
(a) providing a cell which expresses a GABA(A) receptor and a YFP molecule having the amino acid sequence of SEQ ID NO: 6;
(b) contacting said cell with GABA and iodide;
(c) contacting said cell with a test compound; and
(d) determining whether said test compound modulates the activity of said GABA receptor.

11. A cell-based assay for identifying a compound that modulates the activity of a GABA receptor, comprising the steps of:
(a) providing a cell which expresses a GABA(A) receptor and a yellow fluorescent protein molecule encoded by the nucleotide sequence of SEQ ID NO:5;
(b) contacting said cell with GABA and iodide;
(c) contacting said cell with a test compound; and
(d) comparing the fluorescence of said yellow fluorescent protein molecule prior to and subsequent to said step of contacting said cell with a test compound to determine whether said test compound modulates the activity of said GABA receptor.

12. A nucleic acid molecule comprising the nucleotide sequence of SEQ IDNO:5.

13. A vector comprising said nucleic acid molecule of claim 12.

14. A host cell comprising said vector of claim 13.

15. A polypeptide expressed by said host cell of claim 14.

16. A polypeptide encoded by said nucleic acid molecule of claim 12.

17. A polypeptide comprising the amino acid sequence set forth in SEQ ID NO:6.

18. A nucleic acid molecule consisting of the nucleotide sequence of SEQ ID NO:5.

19. A polypeptide encoded by the nucleic acid of claim 19.


SEQUENCE LISTING (6 sequences)

SEQ ID NO: 1 - DNA, 34 bp, Aequorea victoria
ctacaacagccagaacgtctatctcatggccgac

SEQ ID NO: 2 - DNA, 34 bp, Aequorea victoria
gtcggccatgagatagacgttctggctgttgtag

SEQ ID NO: 3 - DNA, 27 bp, Aequorea victoria
gaccctgaagttaatctgcaccaccgg

SEQ ID NO: 4 - DNA, 27 bp, Aequorea victoria
ccggtggtgcagattaacttcagggtc

SEQ ID NO: 5 - DNA, 720 bp, Aequorea victoria
gccaccatggtgagcaagggcgaggagctgttcaccggggtggtgcccatcctggtcgagctggacggcgacgtaaacggccacaagttcagcgtgtccggcgagggcgagggcgatgccacctacggcaagctgaccctgaagttaatctgcaccaccggcaagctgcccgtgccctggcccaccctcgtgaccaccttcggctacggcgtgcagtgcttcgcccgctaccccgaccacatgcgccagcacgacttcttcaagtccgccatgcccgaaggctacgtccaggagcgcaccatcttcttcaaggacgacggcaactacaagacccgcgccgaggtgaagttcgagggcgacaccctggtgaaccgcatcgagctgaagggcatcgacttcaaggaggacggcaacatcctggggcacaagctggagtacaactacaacagccagaacgtctatctcatggccgacaagcagaagaacggcatcaaggtgaacttcaagatccgccacaacatcgaggacggcagcgtgcagctcgccgaccactaccagcagaacacccccatcggcgacggccccgtgctgctgcccgacaaccactacctgagctaccagtccgccctgagcaaagaccccaacgagaagcgcgatcacatggtcctgctggagttcgtgaccgccgccgggatcactctcggcatggacgagctgtac

SEQ ID NO: 6 - protein, 241 aa, Aequorea victoria
ATMVSKGEELFTGVVPILVELDGDVNGHKFSVSGEGEGDATYGKLTLKLICTTGKLPVPWPTLVTTFGYGVQCFARYPDHMRQHDFFKSAMPEGYVQERTIFFKDDGNYKTRAEVKFEGDTLVNRIELKGIDFKEDGNILGHKLEYNYNSQNVYLMADKQKNGIKVNFKIRHNIEDGSVQLADHYQQNTPIGDGPVLLPDNHYLSYQSALSKDPNEKRDHMVLLEFVTAAGITLGMDELYK